(19) United States
(12) Patent Application Publication
(10) Pub. No.: US 2020/0175457 A1
(43) Pub. Date: Jun. 4, 2020

(54) EVALUATION OF ACTOR AUDITIONS

(71) Applicant: International Business Machines Corporation, Armonk, NY (US)

(72) Inventors: Srikanth Govindaraj Tamilselvam, Chennai (IN); Amrita Saha, Bangalore (IN); Pankaj Satyanarayan Dayama, Bangalore (IN); Priyanka Agrawal, Bangalore (IN)

(21) Appl. No.: 16/208,373

(22) Filed: Dec. 3, 2018

(51) Int. Cl. G06Q 10/06; G06K 9/62

(52) U.S. Cl. CPC G06Q 10/063112; G06K 9/627; G06Q 10/06393; G06Q 10/06398

(57) ABSTRACT

One embodiment provides a method, including: receiving a script for a performance requiring at least one actor; receiving a profile for each of a plurality of actors, wherein each actor profile identifies attributes of the corresponding actor; identifying a given portion of the script to be used for an audition of at least one of the plurality of actors, wherein the identifying comprises (i) evaluating aspects of each portion of the script, (ii) scoring, based upon the evaluation, each portion of the script, and (iii) ranking the portions of the script based upon the score; selecting at least one actor from the plurality of actors for performance of the audition corresponding to the given portion of the script, wherein the selecting comprises evaluating attributes of the actors with respect to the given portion of the script; and recommending at least one actor and at least one portion of the script for an audition based upon the selected at least one actor.

### BACKGROUND

Auditioning for a role in a movie, TV show, or theatrical play has always been common practice. A script is supplied by the casting director and the person auditioning must translate an outlined portion of the script into a lively scene. Generally, not only does the actor have to read the script, but they must interpret the script, including interpreting and presenting the emotion of the character, interpreting and presenting the movements of the character, and the like. The casting director wants to see how the person auditioning for a role interprets that role and whether that interpretation fits with the casting director's perception of the role. The auditioning process is regularly a multi-step process so callbacks are a common occurrence, thereby creating a lengthy auditioning and actor selection process. In some cases an audition or callback may require the auditioning person to read a part of the script with another actor representing another character who is present in the scene. For example, the actor representing the other character may already be cast for a role and the cast director may want to see how the auditioning person works with or matches the already-cast actor. However, finding the correct match with the already-cast actor may be a difficult task and may take an excessive amount of time.

In an effort to evaluate his/her performance, the auditioning person may bring a tape recorder, or other recording device, to record the audition. Auditioning for a role is a competition between actors, and evaluation of an actor's performance may result in greater success in the next audition. Aside from the competitive aspect, auditioning may also help an actor find his/her niche acting style and it may build confidence. Recording the audition allows the actor to replay the audition and may provide insight on verbal areas of improvement. However, it may be difficult to completely evaluate an actor solely on verbal cues, especially when the roles being auditioned for are dependent on an actor's charisma and/or stage presence.

### BRIEF SUMMARY

In summary, one aspect of the invention provides a method comprising: receiving a script for a performance requiring at least one actor; receiving a profile for each of a plurality of actors, wherein each actor profile identifies attributes of the corresponding actor; identifying a given portion of the script to be used for an audition of at least one of the plurality of actors, wherein the identifying comprises (i) evaluating aspects of each portion of the script, (ii) scoring, based upon the evaluation, each portion of the script, and (iii) ranking the portions of the script based upon the score; selecting at least one actor from the plurality of actors for performance of the audition corresponding to the given portion of the script, wherein the selecting comprises evaluating attributes of the actors with respect to the given portion of the script; and recommending at least one actor and at least one portion of the script for an audition based upon the selected at least one actor.

Another aspect of the invention provides an apparatus, comprising: at least one processor; and a computer readable storage medium having computer readable program code embodied therewith and executable by the at least one processor, the computer readable program code comprising: computer readable program code configured to receive a script for a performance requiring at least one actor; computer readable program code configured to receive a profile for each of a plurality of actors, wherein each actor profile identifies attributes of the corresponding actor; computer readable program code configured to identify a given portion of the script to be used for an audition of at least one of the plurality of actors, wherein the identifying comprises (i) evaluating aspects of each portion of the script, (ii) scoring, based upon the evaluation, each portion of the script, and (iii) ranking the portions of the script based upon the score; computer readable program code configured to select at least one actor from the plurality of actors for performance of the audition corresponding to the given portion of the script, wherein the selecting comprises evaluating attributes of the actors with respect to the given portion of the script; and computer readable program code configured to recommend at least one actor and at least one portion of the script for an audition based upon the selected at least one actor.

An additional aspect of the invention provides a computer program product, comprising: a computer readable storage medium having computer readable program code embodied therewith, the computer readable program code executable by a processor and comprising: computer readable program code configured to receive a script for a performance requiring at least one actor; computer readable program code configured to receive a profile for each of a plurality of actors, wherein each actor profile identifies attributes of the corresponding actor; computer readable program code configured to identify a given portion of the script to be used for an audition of at least one of the plurality of actors, wherein the identifying comprises (i) evaluating aspects of each portion of the script, (ii) scoring, based upon the evaluation, each portion of the script, and (iii) ranking the portions of the script based upon the score; computer readable program code configured to select at least one actor from the plurality of actors for performance of the audition corresponding to the given portion of the script, wherein the selecting comprises evaluating attributes of the actors with respect to the given portion of the script; and computer readable program code configured to recommend at least one actor and at least one portion of the script for an audition based upon the selected at least one actor.

A further aspect of the invention provides a method, comprising: obtaining an audition of an actor, wherein the audition corresponds to an identified character within an identified portion of a script; extracting theatrical characteristics of the actor during performance of the audition; retrieving at least one previously recorded performance of the identified portion of the script, wherein the at least one previously recorded performance is identified as a desired performance; evaluating the audition by comparing the theatrical characteristics of the actor to theatrical characteristics identified in the at least one previously recorded performance; and providing feedback to the actor based upon the evaluation.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of recommending an actor and portion of a script for an audition.

FIG. 2 illustrates an example of evaluating an audition performed by an actor and providing feedback to the actor.

FIG. 3 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

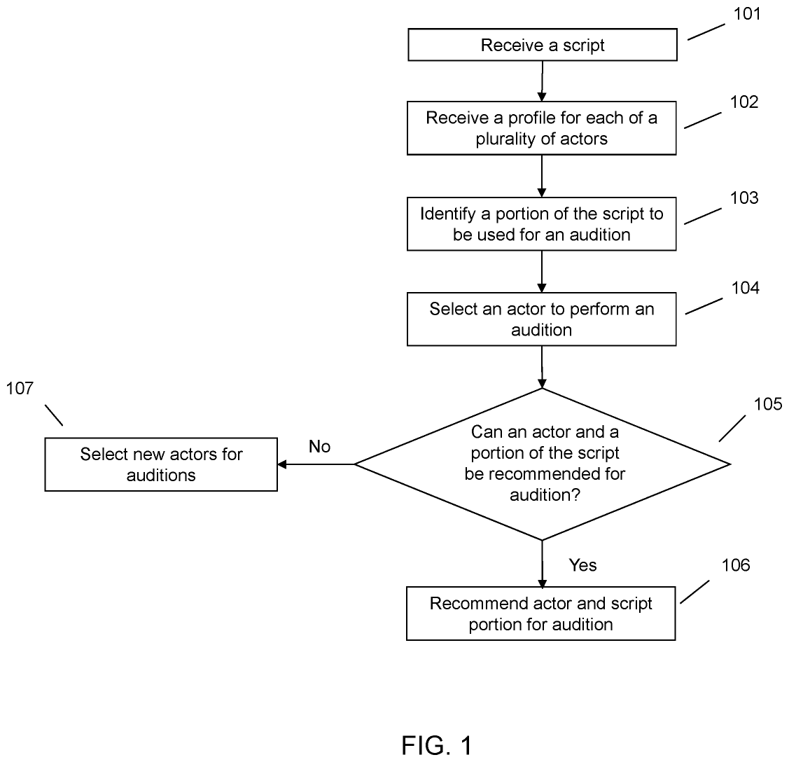

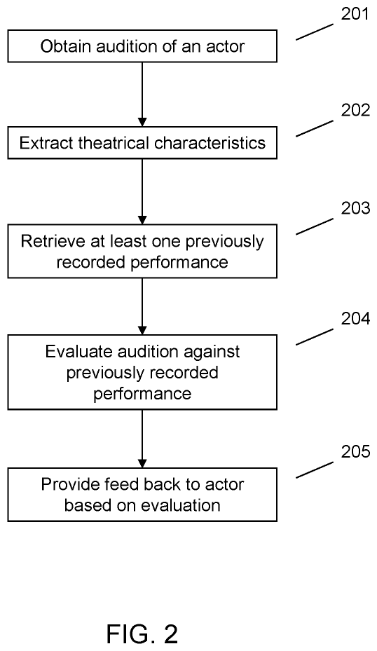

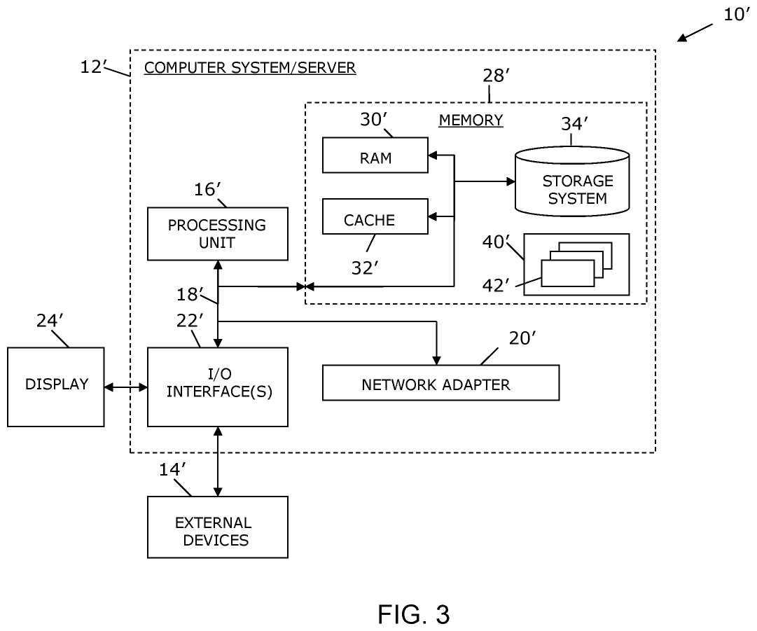

Specific reference will be made here below to FIGS. 1-3. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, all of the process steps, components and outputs discussed with respect to FIGS. 1-2 can be performed or utilized by way of a processing unit or units and system memory such as those indicated, respectively, at 16′ and 28′ in FIG. 3, whether on a server computer, a client computer, a node computer in a distributed network, or any combination thereof.

Both the person auditioning for a role (auditioner) and the casting director holding the audition must prepare for the audition. For both parties this can be a very time consuming process. For example, the auditioner can attempt to learn what he/she can about the role prior to an audition to provide their best performance. However, information is not always available that would allow the auditioner to identify specifics about the role. Additionally, the auditioner can review auditions or roles that he/she previously performed to identify tendencies or identify characteristics that should be adjusted. Usually, in conventional systems, the auditioner only has access to a verbal recording of these previously performed auditions or roles. Listening for specific verbal tendencies may help an auditioner recognize verbal tendencies that should be adjusted. However, it may be difficult for an auditioner to unbiasedly evaluate himself/herself. Additionally, the recording itself may be difficult to evaluate, for example, the recording may be of poor quality, include dialogue between two or more actors, or the like. The addition of background noise or additional actors in a scene may make it more difficult to evaluate the performance from the recording because of the extra noise or multiple voices present. Thus, the auditioner may not be able to accurately evaluate the performance. Additionally, simply having a voice recording does not allow for evaluation of poise, stage presence, and other visual characteristics.

For a casting director, preparing for an audition consists of finding possible actors, culling the list to a list of actors that should be called in for an audition, generating a list of all auditioners that will be auditioning, identifying history and past work for each auditioner, selecting a portion of the script to be used for each audition, determining if the script portion requires more than one actor at a time during the audition, and the like. Aside from remaining organized, a casting director may not do much more than listen to and rate auditions. However, it may be difficult for a casting director to hear the same role being auditioned for by numerous auditioners and accurately evaluate all the auditioners. For example, while a casting director may be employed to listen to around one hundred auditions per role, the casting director may become uninterested in auditions after a certain point in the process. The lack of interest may stem from the quality of the auditions, for example, if the majority of the auditioners do not accurately portray the role to the degree that the casting director desires, the casting director may lose interest in the auditioning process. Thus, the casting director may not be able to apply the attention needed to evaluate an audition, which may cause a good audition to go unnoticed.

The most common method of evaluating an audition is having an evaluator critiquing and evaluating the audition, which can be relatively subjective. Additionally, evaluators may feel differently about auditions based upon different factors, for example, the time of day, the mood of the evaluator, the number of auditions already evaluated, and the like. For an evaluator, the evaluation of an audition may depend on something as simple as disliking the sound of a particular auditioner's voice, or it may be more complicated as it relates to the stage presence or auditioner's interpretation of the role. However, it may be difficult to evaluate an auditioner using only the acting skills presented in an audition. For example, an auditioner may be an actor that has prior experience with a similar role, but the actor may do poorly at the audition. Thus, the evaluator may not be may not be able to make a good decision based solely on a single performance in an audition. Therefore, an auditioner who may be perfect for the part but who had a bad audition may go unnoticed.

A technique that may help finding the best actor for a part, or finding a part for an actor, is using a casting agent. Originally, casting agents were people paid to find work for an actor or find actors for work. Casting agents may work as an entity that can receive information from both actors and production companies, identify actors that may be appropriate for a particular role, and provide a recommendation to the actor and/or production company regarding an audition. While the use of casting agents does help get work for the actor and find actors for certain roles, employing a casting agent may become expensive for both the actor and the production company. Additionally, the actor may not be able to afford the services of a casting agent at all.

Another technique that may be employed by an actor is the use of a software application that allows an actor to create a profile. The production company can then access the site containing the actor profiles and attempt to find an actor suitable for a particular rule. The production company can also use the application to advertise for auditions for particular roles. While these applications may help an actor find possible auditions, the production company does not receive the same kind of benefit. The production company may upload an advertisement for an audition, but since any of the actors may apply for the audition, the production company does not know the type of talent of the person applying for the audition and must, therefore, rely on the traditional evaluation technique. Additionally, no current techniques allow for an evaluation of the audition that would help the actor perform better.

Accordingly, the techniques and systems described herein provide a system and technique for evaluating actors from profiles, identifying portions of a script to be used for an audition, and thereafter recommending both actors and script portions for auditions. Additionally, the described system provides a technique for evaluating an actor's audition and providing feedback to the actor based upon that evaluation. The system receives a script that requires an actor for one or more characters within the script. The system then receives a profile for a plurality of actors that identifies attributes of the actor, for example, any special skills, previously performed roles, emotional characteristics, physical characteristics, and the like.

The system identifies a portion of the script to be used for an audition; for example, the system may identify that one portion of the script that would result in an audition that would provide a good illustration of the character characteristics. To identify the portion of the script, the system may evaluate different aspects of the script (e.g., centrality of the character, the number of characters in the script portion, genre of the script, etc.), score each portion of the script, and rank the portions of the script based upon the scores. The portion of the script having the highest score may then be recommended for the audition. Based upon the script portion, the system can select an actor from the actor profiles that should be recommended for an audition. The selection of the actor may include evaluating the attributes of the actor against the aspects of the script to identify the actor who most closely fits the character in the script. As the recommended actors are performing the auditions, the system can evaluate the actors against a previously recorded performance and provide feedback to the actor based upon this evaluation.

Such a system provides a technical improvement over current systems for actor evaluation by providing a system that can automatically recommend actors for auditions, recommend script portions for auditions, and provide feedback to an actor who performed an audition. Rather than traditional evaluation techniques, the system can cull the list of potential actors before any auditions occur based upon a profile of the actor, including previously performed roles. This greatly reduces the number of auditions that a casting director has to evaluate. Additionally, the system can assist in automatically evaluating the audition based upon comparing the audition to a desired role portrayal. Finally, the system can provide feedback to the actor regarding the audition, where the feedback is not just based upon audio recordings. Accordingly, the actor can learn how to perform better in subsequent auditions from the automated feedback, which is not provided in conventional systems. Thus, the described system reduces the time necessary for casting a project by providing higher quality auditions. Additionally, since auditioners of all talent levels will be using the system, the described system provides a technique that provides, to all who auditioned, feedback on possible improvements to their audition. Such system features are not possible using conventional methods.

FIG. 1 illustrates a method for evaluating actors from profiles, identifying portions of a script to be used for an audition, and thereafter recommending both actors and script portions for auditions. At 101 the system may receive a script for a performance requiring at least one actor. For example, the casting director, or other user, may input information regarding the script or other performance document. Additionally, the system may receive other information, for example, the number of open roles in a scene or performance, genre, preferred actors, or the like.

Alternatively, the system may determine additional information from the script. For example, the system may analyze the script to determine how many actors are needed, the genre of the script, the centrality of a character within a portion of the script, the sentiment of a character in a portion of the script, a relationship graph between characters within the script, special attributes needed for a particular character, an evolution graph of an character, or the like. In determining the additional information the system may use an intermediate model. The intermediate model may not only use the information provided by the user, but may also access past scripts or productions to assist in classifying different aspects of the script. For example, in determining the genre of a script or production, the system may use a classification model that has been trained using previously produced scripts. The script can then be fed to this classification model, and the model will provide information regarding the genre of the script.

In determining the centrality of a character within a portion of the script, the system is attempting to determine how important the character, and therefore—the actor, is within the script. This determination is based upon the length of time that the character is present within the script (e.g., how many scenes is the character in, whether the character is one of the main characters within a scene, the percentage of time that the character is talking, etc.), the relationship of the character with respect to the genre (e.g., a love interest in a romantic comedy may be more important than a love interest in a thriller), and the like. The system may then provide a ranked order of dominance or centrality of the character within the script. The importance of characters may be used to generate a relationship graph that identifies relationships between each of the characters within the script. This may later be used to identify if some auditions should occur between pairs of actors.

The system may also determine the sentiment of the character throughout the script. In determining the sentiment, the system may perform a sentiment analysis throughout the script and then generate a sentiment graph that illustrates the range of sentiment felt by the character throughout the script. This sentiment analysis provides insight on the range of sentiment that will need to be portrayed by an actor chosen to portray the character. The sentiment graph may also be used to produce an evolution graph of the character throughout the script. The evolution graph may not only illustrate the sentiment of the character throughout the script, but may also include different characteristics (e.g., age, special attributes, costumes, etc.) of the character that occur throughout the script.

At 102 the system may receive a profile for each of a plurality of actors. These actors may be actors that have previously been identified by a user, actors that have applied for an audition, actors that are listed with a casting agent or on a casting application, or the like. Each of the actor profiles identifies different attributes of the actor. For example, the profile may identify previously performed roles, special skills or attributes (e.g., singing, dancing, ventriloquism, foreign accent, etc.), physical characteristics, or the like. If the script requires a particular attribute that is not listed on a profile for an actor, the system may attempt to determine whether that actor has the required attribute by accessing historical auditions or other performances of the actor and identifying whether the actor portrayed that attribute in any preceding performance.

At 103 the system may identify a portion of the script to be used for an audition. In identifying a portion of the script to be used for an audition, the system may evaluate the different aspects of each portion of the script. The different aspects may be identified from the intermediate model as described herein. The aspects produced by the intermediate model may then be classified using a multi-kernel based classifier which translates each individual aspect into kernels. The multi-kernel classifier identifies patterns and then groups aspects identified as similar from the patterns into a single kernel. The kernels may provide an easier classification and scoring process for ranking parts of the script. The system, using the kernels or another technique, may then score each portion of the script. From the scores the system can rank the portions of the script. Thus, using the kernels, or another scoring technique, the system can rank the parts or portions of the script to identify a portion of the script to be used for an audition. For example, the system may identify a particular portion of the script to be used for an audition for a particular character based upon the system determining that the portion of the script best represents the character.

In selecting a portion of the script, the system may choose a portion of the script that portrays an important character feature better than other portions of the script. For example, one portion of the script may include a scene where the character's feature is more pronounced than in other scenes. As an example, the system may identify that a particular sentiment of the character is pivotal for the overall quality of the production. Accordingly, the system may identify the portion of the script where this sentiment from the character is most predominant. As another example, the system may determine that a particular relationship between two characters is important to the production. Accordingly, the system may identify a portion of the script that includes an interaction between these characters and, thereafter, select this portion of the script for the audition.

At 104 the system may select at least one actor from the plurality of actors for performance of the audition corresponding to the portion of the script. Although discussed with the system selecting the portion of the script first, these steps may be reversed where an actor is identified and then a portion of the script is identified for that actor. For example, if a particular actor of interest has a special skill, the system may select a portion of the script that highlights this special skill. Alternatively, the selection of a portion of the script and the selection of the actor may happen in conjunction with each other, with portions of each selection process feeding into the selection process of the other. For example, if an actor has already been selected to represent one character within the script, this selection may be fed into the script selection portion in order to identify a portion of the script to be used for auditioning a co-actor. In other words, the script selection step and the actor selection step may work in conjunction in order to select the most suitable combination of script portion and actor for auditioning purposes.

To select the actor, the system may evaluate attributes of the actor, for example, as found in the actor profiles, with respect to the portion of the script. For example, if the script portion requires an actor having a special ability or attribute, the system may identify which actors have that special ability or attribute. The evaluation of the attributes with respect to the script portions may include matching profiles or attributes of the actors with the kernels that were generated from the intermediate models. In evaluating the attributes, the system may weight different attributes of an actor based upon the portion of the script or the importance of the attribute with respect to the character. For example, if the portrayed character is of a certain age, the system may determine whether this character feature is important, for example, based upon user input, based upon historical portrayals of the character, or the like. If the system determines that this character feature is important, the system may weight this particular actor attribute higher than other attributes.

In other words, the system may optimize the script selection and/or actor selection using a multiple objective optimization problem. In generating the multiple objectives the system may calculate an importance score of the selected scene in the overall production. For example, if the selection script portion is not that important to the overall production, then whether the actor has the given attribute may not be that important for the production. Thus, the multiple objectives include maximizing the weight features that are to be evaluated for a particular actor and a particular scene against the importance of the scene in the overall production. The constraints on this optimization problem include a length of time for an audition, and therefore a length of time for the scene, how central the character is within the selected scene, the weights assigned to the different character attributes, and the like. From this optimization, the system can select the script portion and the actor to portray the character within the audition.

At 105 the system may determine whether an actor and/or script portion can be recommended for an audition. If either the actor or script portion cannot be identified, the system may select new actors or a new script portion at 107. If, however, an actor and/or script portion can be identified at 103 and 104, the system may recommend both the actor and the script portion at 106.

As an example, the system may recommend twin actresses and an older male actor that may all have experience in a horror television series for three roles in a horror movie. In making this recommendation, the system may determine that the script provided by the casting director is a thriller, the number of actors needed is three, and twin actresses are required. Using the script, the system may determine that the lead character needs to be male and has multiple sentiment changes throughout the script, thereby increasing the complexity of the portrayal of the sentiment of the character. For example, the system may produce a sentiment graph that illustrates the changing sentiment of the character throughout the production. The system may determine from the older male actor's past recordings or performances that he may be a good fit for the role because of success in lead roles and roles which include ranging sentiments.

Additionally, the system may create a relationship graph identifying the relationship of the characters. This relationship graph can be used by the system to identify possible favorable actor combinations based upon the history of the potential actors. Using the previous example, the system may identify that the twin actresses and the older male actor have been in productions together and have portrayed similar relationships as those found in the present script. Auditioner pairs or groups may be vital when an auditioner is trying to receive a role, and using a ranking system may result in favorable pairs; thus, permitting all auditioners to perform at their highest level. Such ranking and classification of auditioner traits produced by the system may provide a casting director with favorable auditions and audition pairs. Additionally, the quality of auditions may be increased while simultaneously decreasing the length spent on the audition process.

FIG. 2 illustrates a method for evaluating an actor's audition and providing feedback to the actor based upon that evaluation. While auditions are ongoing the system may also evaluate the auditions. For example, a casting director may hold auditions based upon the recommended script portions and recommended actors. During the audition the auditioners may be recorded with the permission of the auditioner. Thus, the system may receive or otherwise obtain an audition of an actor at 201. This audition corresponds to an identified character within an identified portion of the script. From the audition the system can extract theatrical characteristics of the actor during the performance of the audition at 202. Theatrical characteristics may include genre, drama, emotion, sentiment, body language, stage presence, gestures, facial expressions, and the like.

The system may then retrieve at least one previously recorded performance of the identified portion of the script at 203. This previously recorded performance may include the performance of the script during another production, by another auditioner, or the like. In any case, this performance may be selected or identified as a desired performance, meaning this performance is the performance being used as the standard for comparing all other performances of this script portion and character. The previously recorded performances may be included in a database of previously recorded auditions and published projects such as, but not limited to, movies, plays, commercials, and television shows. The system may then label the previously recorded performance with the different theatrical characteristics. Alternatively, these previously recorded performances may already be labeled with the theatrical characteristics.

At 204 the system may evaluate the audition against the previously recorded performance. In evaluating an audition, a system may compare the auditions for a role with past scenes and auditions that are similar in scope. Based on information provided by the system and/or a user, the evaluation system may match a current audition against past auditions and published projects based on common variables, e.g., genre, setting, and actor sentiment. An evaluation engine may search for key features such as speech and body language, and gestures and facial expressions that may be ideal in the role being auditioned for as described by a casting director. A current audition may then be overlaid onto past auditions and published projects selected by the system that were deemed similar in scope.

Within the evaluation system, a trained generative adversarial network (GAN) may compare a current audition to past auditions and published projects. A GAN utilizes two neutral networks, a generator and a discriminator, which may successfully compare recordings and may produce a ranking or evaluation for an auditioner. The generator in a GAN may have been trained to generate the overlaying of recordings on each other, and a discriminator in a GAN may be trained to recognize discriminations between the overlaid recordings. A discriminator may evaluate the current audition against the previously recorded performance based on three primary features: naturalness, persuasiveness, and character-consistency. The evaluation score of the discriminator is increased when the three features are similar in the current audition and the previously recorded performance. The more similar the overlaid recordings are to each other, the higher the evaluation score. Each feature may have an individual score which are then aggregated together to produce a single ranking. For example, an audition may be scored as 0.7 for naturalness, 0.5 for persuasiveness, and 0.6 for character-consistency, which may result as a final ranking score of 0.6. The ranking values used may be adjusted based on a casting director's personal preference. Based on the final ranking of an auditioner, a role may be offered to the auditioner with the highest score.

Regardless of whether the actor receives a role in a project, there is always room for improvement. Thus, the evaluation system may provide feedback to the actor based upon the evaluation at 205. An evaluation system may include an attention network that tracks different aspects of the audition where the acting quality was poor or maybe even where the acting quality was high. For example, the discriminator may first recognize that the current audition and the recordings overlaid are significantly different at particular points within the performance when compared. An attention network may take note of these points, notify a user of these points, and may provide recommendations and insight for possible acting improvements. Possible improvements based on an audition may be accessible by all auditioners, not just those who receive a role, and may be accessed at any time through a system. An attention network may also recommend, to an auditioner and casting director, different roles in which an auditioner may find more success. For example, an auditioner may audition to play a soft-spoken, innocent teenager;—however, because of their demeanor and tone of voice, the auditioner may be recommended to play a more outgoing, young twenty-year-old. An attention network may also recommend not casting an auditioner because of shortcomings of the current audition and profile of the candidate pool.

Thus, the described system and method provide an improvement over conventional system for choosing script portions and actors for auditions and for evaluating auditions. The system is able to identify which script portions most accurately portray important character features, which reduces the length of time a casting director or other user must spend to find a suitable script portion. Additionally, since the system is able to identify potential actors to be recommended for auditions based upon comparison of the actor profile to necessary character attributes, the length of auditions is significantly shortened and the casting director is provided with better quality auditions. Additionally, since the system provides comparisons of a current audition against past auditions and published work, the system provides a technique for providing feedback to all auditioners regarding possible improvements pertaining to the actor's acting skill and/or attributes. These features are not presently possible with conventional systems and/or processes.

As shown in FIG. 3, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
receiving a script for a performance requiring at least one actor;
receiving a profile for each of a plurality of actors, wherein each actor profile identifies attributes of the corresponding actor;
identifying a given portion of the script to be used for an audition of at least one of the plurality of actors, wherein the identifying comprises (i) evaluating aspects of each portion of the script, (ii) scoring, based upon the evaluation, each portion of the script, and (iii) ranking the portions of the script based upon the score;
selecting at least one actor from the plurality of actors for performance of the audition corresponding to the given portion of the script, wherein the selecting comprises evaluating attributes of the actors with respect to the given portion of the script; and
recommending at least one actor and at least one portion of the script for an audition based upon the selected at least one actor.

2. The method of claim 1, wherein the identifying a given portion of the script comprises identifying a centrality of a character to be represented by an actor within the given portion of the script based upon (i) the length of the part of the character within the given portion and (ii) the relationship of the character with respect to the script.

3. The method of claim 1, wherein the identifying a given portion of the script comprises identifying a sentiment of a character to be represented by an actor within the given portion of the script; and
wherein the selecting comprises comparing the attributes of an actor to the sentiment of the character.

4. The method of claim 1, wherein the identifying a given portion of the script comprises identifying a portion of the script including more than one character; and
wherein the selecting at least one actor comprises selecting more than one actor based upon a relationship between the more than one character and attributes of the more than one actor.

5. The method of claim 1, wherein the selecting at least one actor comprises identifying a special attribute of a character within the given portion of the script and identifying an actor having the special attribute.

6. The method of claim 1, wherein the selecting at least one actor comprises (i) training an intermediate model using a previous set of auditions selected for similar scripts, (ii) classifying individual aspects of the given portion of the script, as identified from the intermediate model, into kernels, and (iii) matching profiles of the plurality of actors with the kernels.

7. The method of claim 6, wherein the selecting at least one actor comprises optimizing the selection of the at least one actor based upon (i) weighted attributes of an actor for the given portion of the script and (ii) an importance score calculated for the given portion of the script based upon the importance of the given portion of the script to the performance.

8. The method of claim 1, comprising evaluating an audition of an actor by comparing the audition performed by the actor to another acting scene similar to the audition.

9. The method of claim 8, wherein the evaluating comprises comparing the actions of the actor within the audition to a personality of a character represented by the actor within the given script.

10. The method of claim 8, comprising providing a recommendation for improvement of the actor based upon the evaluated audition.

11. An apparatus, comprising:
at least one processor; and
a computer readable storage medium having computer readable program code embodied therewith and executable by the at least one processor, the computer readable program code comprising:
computer readable program code configured to receive a script for a performance requiring at least one actor;
computer readable program code configured to receive a profile for each of a plurality of actors, wherein each actor profile identifies attributes of the corresponding actor;
computer readable program code configured to identify a given portion of the script to be used for an audition of at least one of the plurality of actors, wherein the identifying comprises (i) evaluating aspects of each portion of the script, (ii) scoring, based upon the evaluation, each portion of the script, and (iii) ranking the portions of the script based upon the score;
computer readable program code configured to select at least one actor from the plurality of actors for performance of the audition corresponding to the given portion of the script, wherein the selecting comprises evaluating attributes of the actors with respect to the given portion of the script; and
computer readable program code configured to recommend at least one actor and at least one portion of the script for an audition based upon the selected at least one actor.

12. A computer program product, comprising:
a computer readable storage medium having computer readable program code embodied therewith, the computer readable program code executable by a processor and comprising:
computer readable program code configured to receive a script for a performance requiring at least one actor;
computer readable program code configured to receive a profile for each of a plurality of actors, wherein each actor profile identifies attributes of the corresponding actor;
computer readable program code configured to identify a given portion of the script to be used for an audition of at least one of the plurality of actors, wherein the identifying comprises (i) evaluating aspects of each portion of the script, (ii) scoring, based upon the evaluation, each portion of the script, and (iii) ranking the portions of the script based upon the score;
computer readable program code configured to select at least one actor from the plurality of actors for performance of the audition corresponding to the given portion of the script, wherein the selecting comprises evaluating attributes of the actors with respect to the given portion of the script; and
computer readable program code configured to recommend at least one actor and at least one portion of the script for an audition based upon the selected at least one actor.

13. The method of claim 12, wherein the identifying a given portion of the script comprises identifying a centrality of a character to be represented by an actor within the given portion of the script based upon (i) the length of the part of the character within the given portion and (ii) the relationship of the character with respect to the script.

14. The method of claim 12, wherein the identifying a given portion of the script comprises identifying a sentiment of a character to be represented by an actor within the given portion of the script; and
wherein the selecting comprises comparing the attributes of an actor to the sentiment of the character.

15. The method of claim 12, wherein the identifying a given portion of the script comprises identifying a portion of the script including more than one character; and
wherein the selecting at least one actor comprises selecting more than one actor based upon a relationship between the more than one character and attributes of the more than one actor.

16. The method of claim 12, wherein the selecting at least one actor comprises identifying a special attribute of a character within the given portion of the script and identifying an actor having the special attribute.

17. The method of claim 12, wherein the selecting at least one actor comprises (i) training an intermediate model using a previous set of auditions selected for similar scripts, (ii) classifying individual aspects of the given portion of the script, as identified from the intermediate model, into kernels, and (iii) matching profiles of the plurality of actors with the kernels.

18. The method of claim 17, wherein the selecting at least one actor comprises optimizing the selection of the at least one actor based upon (i) weighted attributes of an actor for the given portion of the script and (ii) an importance score calculated for the given portion of the script based upon the importance of the given portion of the script to the performance.

19. The method of claim 12, comprising evaluating an audition of an actor by comparing the audition performed by the actor to another acting scene similar to the audition, wherein evaluating provides a recommendation for improvement of the actor based on the audition.

20. A method, comprising:
obtaining an audition of an actor, wherein the audition corresponds to an identified character within an identified portion of a script;
extracting theatrical characteristics of the actor during performance of the audition;
retrieving at least one previously recorded performance of the identified portion of the script, wherein the at least one previously recorded performance is identified as a desired performance;
evaluating the audition by comparing the theatrical characteristics of the actor to theatrical characteristics identified in the at least one previously recorded performance; and
providing feedback to the actor based upon the evaluation.
